(19) United States
(12) Patent Application Publication
(10) Pub. No.: US 2025/0091892 A1
(43) Pub. Date: Mar. 20, 2025

(54) MINERAL CARBONATION IN ALKALINE AQUEOUS SCRUBBING SYSTEM

(71) Applicant: EXXONMOBIL TECHNOLOGY AND ENGINEERING COMPANY, Spring, TX (US)

(72) Inventors: Joseph S. Famolaro, Spring, TX (US); Theresa J. Hochhalter, Montgomery, TX (US); Masaaki Sugita, The Woodlands, TX (US)

(21) Appl. No.: 18/884,522

(22) Filed: Sep. 13, 2024

Related U.S. Application Data
(60) Provisional application No. 63/582,959, filed on Sep. 15, 2023.

(51) Int. Cl. C01F 11/18; B01D 53/62; B01D 53/78; C01F 5/24

(52) U.S. Cl. CPC C01F 11/181; B01D 53/62; B01D 53/78; C01F 5/24; B01D 2257/504; B01D 2258/0283

(57) ABSTRACT

Systems and methods are provided for using a two-step process to capture CO₂ from a process flue gas in an aqueous solution followed by conversion of the captured CO₂ into metal carbonates for storage, transport, or other potential uses. In the first processing step, CO₂ is removed from a process flue gas by contacting the process flue gas with an aqueous solution at a sufficiently high pH to enhance capture of the CO₂ while reducing or minimizing other impacts on the vessel where capture is performed. The CO₂-enriched aqueous solution is then passed into a second zone, such as a second vessel, for contact with a metal reagent, such as a metal oxide, metal sulfide, metal hydroxide, and/or metal silicate.

### CROSS REFERENCE TO RELATED APPLICATIONS

This Non-Provisional patent application claims priority to U.S. Provisional Patent Application No. 63/582,959, filed Sep. 15, 2023, and titled “Mineral Carbonation In Alkaline Aqueous Scrubbing System”, the entire contents of which is incorporated herein by reference.

### FIELD

A system and corresponding two-step method for capturing CO₂ via mineral carbonation in an alkaline aqueous scrubbing environment are provided.

### BACKGROUND

A variety of current industrial processes create CO₂-containing flue gases that also contain other contaminants. A fluid catalytic cracking (FCC) process is an example of a refinery process where the resulting flue gas typically also contains low levels of sulfur and/or nitrogen compounds. Processing of such a flue gas presents multiple challenges. In addition to CO₂, such flue gases can also potentially contain nitrogen and/or sulfur compounds, where exhaust of such compounds to the atmosphere should be mitigated. Additionally, for flue gases from processes such as FCC processes can also contain fine particles, such as catalyst fines or coke particles, depending on the nature of the process.

Mineral carbonation is a reaction that converts CO₂ and metal oxides, metal hydroxides, and/or metal sulfides into metal carbonates. Forming metal carbonates from CO₂ can provide a variety of advantages in certain situations. For example, if infrastructure is not available for transport of CO₂ to a storage site for fluid-phase CO₂, metal carbonation can provide a way to convert CO₂ into a stable material that can be stored at a location without requiring pressurized storage and/or low temperature storage. As another example, such metal carbonates can be transported to a sequestration site without requiring a pressurized pipeline and/or other specialized infrastructure. As still another example, mineral carbonates can potentially be incorporated into some types of industrial processes, such as incorporation into construction materials (e.g., concrete), use as fillers for paint, paper, and plastic, and/or serving as an input for forming soil enhancers or fertilizers.

Conventionally, mineral carbonation is typically performed as a 1-step gas phase process. In such conventional processes, gas phase CO₂ at high pressure is exposed typically to metal oxides or alternatively metal hydroxides. While mineral carbonation does occur under these conditions, the CO₂ conversion to metal carbonates is limited. It would be desirable to have improved methods for using metal carbonation for processing of CO₂-containing streams such as flue gases.

U.S. Pat. No. 7,618,606 is an example of a 1-step process for performing metal carbonation. A gas phase stream containing CO₂ is directed at a solid sorbent containing calcium oxide. This converts calcium oxide to calcium carbonate. The sorbent can then be regenerated to allow for sequestration or other use of recovered CO₂.

U.S. Patent Application Publication 2010/0221163 describes another example of a 1-step process. A flue gas is passed through a particulate bed containing metal silicates and/or oxides to form metal carbonates.

U.S. Pat. No. 7,919,064 describes methods for capturing CO₂ from a flue gas. The flue gas is contacted with a metal carbonate solution to capture CO₂. The capture is described as being facilitated by equilibrium conversion of carbonate ions to bicarbonate ions in solution. The pH of the capture solution is not specified, but must be below a pH of 9.5 for conversion to bicarbonate ions to occur in any substantial amount.

U.S. Pat. No. 8,333,944 describes methods of sequestering CO₂. CO₂ is added to solutions containing metal hydroxides while maintaining the pH sufficiently below 10 so that precipitation of metal carbonates does not occur during the initial mixing.

U.S. Pat. No. 9,718,693 describes carbonation of metal silicates for long term CO₂ sequestration. A broad range of conditions are described, including high pressure formation of carbonates, but no pH values are described.

### SUMMARY

In an aspect, a method for forming metal carbonates is provided. The method includes contacting a process flue gas comprising 0.1 vol % to 30 vol % CO₂ with an aqueous wash liquid in a wash contacting device associated with a vessel to form a CO₂-depleted gas effluent and a CO₂-enriched wash effluent. The CO₂-enriched wash effluent can have a pH of 9.8 to 13.0 and a carbonate ion content of 0.05 mol/L or more. The method further includes passing at least a portion of the CO₂-enriched wash effluent into a precipitation zone. Additionally, the method includes contacting the at least a portion of the CO₂-enriched wash effluent with at least one of a calcium reagent and a magnesium reagent to form a CO₂-depleted liquid and at least one of calcium carbonate and magnesium carbonate. In some aspects, the at least one of a calcium reagent and a magnesium reagent can correspond to magnesium oxide, magnesium silicate, magnesium hydroxide, magnesium sulfide, calcium oxide, calcium silicate, calcium hydroxide, calcium sulfide, or a combination thereof. In some aspects, the aqueous wash liquid includes at least a portion of the CO₂-depleted liquid. Optionally, the precipitation zone can be in a second vessel.

In another aspect, a system for integrating metal carbonation with a gas phase scrubbing system is provided. The system includes a wash contacting device for contacting a gas flow with an aqueous wash liquid, the wash contacting device having a flue gas inlet, a wash liquid inlet, and a wash fluid outlet, the flue gas inlet being in fluid communication with an overhead gas outlet of at least one of a fluid catalytic cracking process and a fluidized coking process. The system further includes a disengaging vessel having a disengaging fluid inlet in fluid communication with the wash fluid outlet, a gas outlet, and a disengaging effluent outlet. The disengaging vessel can include an aqueous reservoir having a pH of 9.8 to 13.0, the aqueous reservoir containing at least a portion of the aqueous wash liquid. Additionally, the system can include a precipitation vessel having a wash effluent inlet in fluid communication with the wash effluent outlet, a liquid effluent outlet in fluid communication with the wash liquid inlet, a particle inlet, a carbonate solids outlet, and a mixer. The contacting device can optionally include an aqueous wash liquid sprayer for contacting the gas flow with the aqueous wash liquid.

### BRIEF DESCRIPTION OF THE DRAWINGS

FIG. 1 shows an example of a configuration for integrating a two-step metal carbonation process with a scrubbing system.

FIG. 2 shows total carbon solubility (summation of CO₂+carbonic acid+bicarbonate+carbonate) in aqueous medium relative to pH.

FIG. 3 shows the equilibrium concentration for bicarbonate versus carbonate ions in an aqueous saline solution relative to pH.

### DETAILED DESCRIPTION

All numerical values within the detailed description and the claims herein are modified by “about” or “approximately” the indicated value, and take into account experimental error and variations that would be expected by a person having ordinary skill in the art.

### Overview

In various aspects, systems and methods are provided for using a two-step process to capture CO₂ from a process flue gas in an aqueous solution followed by conversion of the captured CO₂ into metal carbonates for storage, transport, or other potential uses. In the first processing step, CO₂ is removed from a process flue gas by contacting the process flue gas with an aqueous solution at a sufficiently high pH to enhance capture of the CO₂ while reducing or minimizing other impacts on the vessel where capture is performed. In some aspects, this can correspond to contacting the process flue gas with an aqueous solution at a pH of 10.0 or more, or 10.5 or more, such as up to 13 or possibly still higher. In this range of pH, equilibrium will favor hydration/protonation of CO₂ to bicarbonate and carbonate anions in solution, and significantly increase total solution capacity of CO2+carbonic acid+bicarbonate+carbonate. The CO₂-enriched aqueous solution is then passed into a second zone, such as a second vessel, for contact with a metal reagent, such as a metal oxide, metal sulfide, metal hydroxide, and/or metal silicate. Contact with the metal reagent results in formation of metal carbonates that will precipitate out in the second zone or vessel (and/or precipitate out in a subsequent zone or vessel). This reduces, minimizes, or avoids precipitation in the flue gas contacting zone, where the precipitation could interfere with operation of other processes in the contacting zone. By using a two-step process, enhanced CO₂ capture can be achieved while reducing, minimizing, and/or avoiding the need to change the primary process flow for handling the process flue gas. Additionally, by using a two step process, the need to compress the process flue gas to substantially higher pressures in order to increase conversion of CO₂ into carbonates can be avoided.

A variety of industrial processes generate process flue gases that contain both CO₂ and at least one other contaminant gas, such as nitrogen-containing contaminant gases (e.g., NOx, NH₃) and/or sulfur-containing contaminant gases (e.g., SO₂, H₂S). Such industrial processes typically have existing facilities and/or equipment for reducing, minimizing, or eliminating the content of such additional contaminant gases from the process flue gas prior to allowing the process flue gas to be exhausted to the atmosphere. In some instances, the process flue gas can also contain small particles or fines. For example, a flue gas from an FCC process can contain catalyst fines that are formed during the catalytic process. As another example, a flue gas from the regenerator of a fluidized coking process can contain coke fines formed from the coke particles that create the fluidized bed. Still other examples can include flue gases from power generation facilities, such as solid fuel power generation facilities.

To handle the additional contaminant gases in the flue gas of an industrial process, the flue gas is often passed through a process device or stage that corresponds to a scrubbing system. An initial step can be to pass the flue gas into a contacting device such as a venturi scrubber to intimately contact the gas with an aqueous wash fluid. Contacting the flue gas with an aqueous wash liquid facilitates removal of targeted gas contaminants such as SO₂/SO₃, as well as particle fines (such as catalyst fines). For a FCC flue gas, the aqueous wash liquid is typically at a pH of roughly 8.0 or less, in order to prevent formation of precipitates in the scrubbing vessel. The aqueous wash liquid accumulates in the bottom of the disengaging drum. This liquid phase can be recycled as the primary source of the aqueous wash liquid. The recycled liquid is supplemented with additional water and caustic (NaOH) in order to maintain both the pH and the level of the aqueous solution in the disengaging vessel.

One of the difficulties with integrating mineral carbonation with a scrubbing system is that formation of additional particles in the disengaging drum needs to be minimized or avoided. The purge system for a disengaging drum is designed to handle either an aqueous solution or a low particle count slurry. Such a purge system is typically not designed to remove substantial quantities of particles. If any appreciable amount of precipitation of carbonates occurs in the disengaging drum, the drum would either need to be cleaned on a much faster schedule than normal (resulting in substantial downtime for the primary process feeding the scrubbing system), or the disengaging drum would need to be redesigned to allow for particle removal.

A second problem with integrating mineral carbonation with a scrubbing system is the typical pH of the scrubbing system. The solubility of CO₂ in aqueous solution is less than 0.1 mol/L at pH values below 10.0. In a traditional scrubbing system, the amount of wash liquid is selected based on other considerations, such as particle removal or removal of nitrogen/sulfur contaminants from the process flue gas. As a result, at a traditional pH of 8.0 or less, the flow rate of wash liquid in a disengaging drum is significantly smaller than the amount that would be needed for performing substantial capture of CO₂. Additionally, when CO₂ is dissolved in water at pH values between roughly 7.0 and 9.0, the resulting form of the CO₂ in the aqueous solution is predominantly as bicarbonate ion, and not the carbonate ion form that can readily form a metal carbonate.

In various aspects, integration of mineral carbonation into a scrubbing system can be enhanced by incorporating the mineral carbonation as a two-step process rather than the conventional single step process. The first stage of the mineral carbonation can be performed in a disengaging drum or similar vessel of a scrubbing system. However, instead of operating the disengaging drum at a conventional pH of 8.0 or less, the aqueous water wash in the disengaging drum is at a pH of 9.8 or more, or 10.0 or more, or 10.5 or more, such as up to 13 or possibly still higher. In some aspects, the pH can be 10.0 to 11.5, or 10.0 to 11.0, or 10.5 to 11.5, or 10.5 to 11.0. This substantially increases the removal rate of CO₂ for a give slurry circulation rate, by promoting hydration/protonation reactions to convert dissolved CO₂ to bicarbonate and carbonate, thus allowing for substantially complete capture of CO₂ from process flue gases. Additionally, increasing the pH to 9.8 or more, or 10.0 or more, or 10.5 or more, changes the equilibrium so that the dominant form of the dissolved CO₂ in solution is as a carbonate ion (CO₂³⁻), and not bicarbonate ion (HCO₃⁻).

By increasing the pH of the wash liquid in the disengaging drum, the amount of CO₂ that can be removed from the flue gas is substantially increased. This facilitates performing a two-step process, where the CO₂-enriched aqueous liquid is then transported to a second zone, such as transport to a second vessel, for forming metal carbonates. In the second zone and/or vessel, the CO₂-enriched aqueous liquid is contacted with one or more metal reagents, such as one or more metal oxides, silicates, sulfides and/or hydroxides, to form metal carbonates in solid form. In some aspects, the one or more metal reagents can correspond to metal reagents containing calcium and/or magnesium. The resulting metal carbonates can then be recovered by any convenient method.

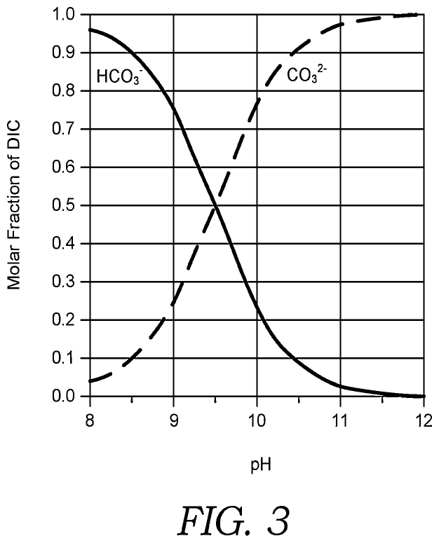

FIG. 3 shows an example of the relative concentrations of bicarbonate and carbonate ions in aqueous solution at various basic pH values. The information shown in FIG. 3 is for an aqueous solution including 5000 ppm of salt (sodium chloride), but is believed to be representative of the equilibrium concentrations at lower salt contents. As shown in FIG. 3, at pH values below 9.5, bicarbonate ions are the dominant form of dissolved CO₂. By contrast, at pH values of 10.0 or higher, little or no bicarbonate ion is present.

### Configuration Example

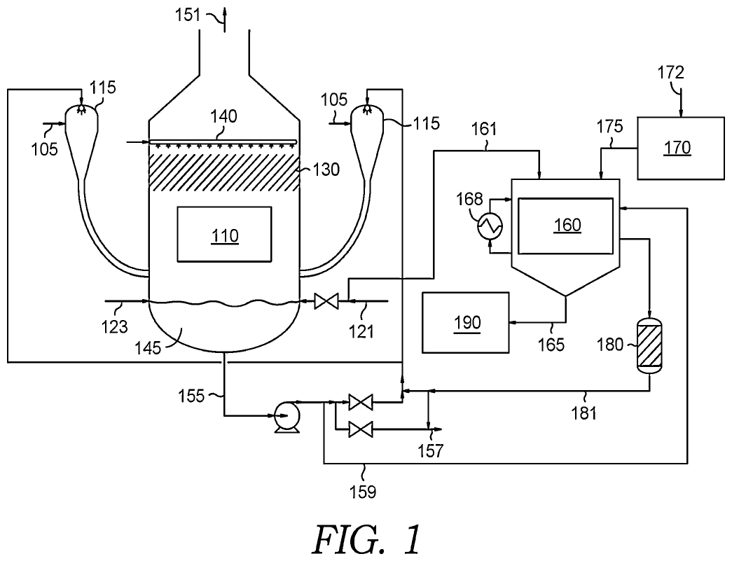

FIG. 1 shows an example of integration of a two-step mineral carbonation process with a scrubbing system. In FIG. 1, vessel 110 represents a disengaging drum or another similar type of vessel that is part of a scrubbing system. In the example shown in FIG. 1, a CO₂-containing stream 105 from a primary process (not shown) is introduced into one or more wash contacting devices 115 that are associated with vessel 110. An example of a CO₂-containing stream 105 is a process flue gas. A wash contacting device 115 can be a Venturi chamber or another convenient device that provides a method for introducing intimate contact between the flue gas and an aqueous wash liquid. In various aspects, the aqueous wash liquid is contacted with the flue gas in the wash contacting device 115 as a spray of the aqueous wash liquid, in order to increase the contact area between the flue gas and aqueous wash liquid. As a result of this contacting, the temperature of the flue gas is reduced to a temperature of less than 100° C., or less than 80° C., such as down to 10° C. or possibly still lower. It is noted that the wash contacting device(s) 115 associated with a vessel 110 can be incorporated into the vessel 110, depending on the scrubber design.

The cooled CO₂-containing gas is then introduced into vessel 110. In vessel 110, gas rises to enter packing material 130, while the high pH aqueous wash liquid from wash contacting device 115 falls into liquid reservoir 145 in the bottom of vessel 110. It is noted that the level of liquid reservoir 145 is below the location where gas and liquid from wash contacting device(s) 115 enters vessel 110, so that the gas flow from wash contacting device 115 is not bubbled through the liquid reservoir. This avoids the more substantial pressure drop that is associated with bubbling a flue gas through a liquid, as opposed to contacting a flue gas with a liquid spray. A supplemental wash dispenser 140 can optionally pass a supplemental wash (such as a water wash) in a counter-current manner through the packing material 130. The packing material 130 increases the contact area between the gas in vessel 110 and the supplemental wash liquid. The optional supplemental wash liquid can assist with removing caustic that may be entrained with the flue gas vapors as the flue gas rises toward the upper exit from the vessel. The downward flowing supplemental wash liquid can further contribute to formation of the liquid reservoir 145 in the bottom of vessel 110. In a traditional configuration, an output flow or wash effluent 155 that exits from the vessel (typically by exiting from the liquid reservoir) can be recycled for use as the aqueous wash in wash contacting vessel 115, while a remaining portion can be purged 157 to remove particles from the vessel 110. The wash effluent 155 corresponds to a CO₂-enriched wash effluent. The upward flowing gas exits 151 from the top of the vessel 110 and passes into an exhaust stack (not shown) or other similar structure. The gas exiting 151 from the vessel corresponds to a CO₂-depleted gas, such as a CO₂-depleted flue gas. In a traditional configuration, additional mitigation of nitrogen and/or sulfur contaminant compounds can be performed upstream or downstream of the scrubbing facility. Make-up quantities of water 121 and base 123 (such as aqueous sodium hydroxide) can be added to vessel 110 to maintain the water level and pH of the liquid reservoir 145. For example, additional water can be provided by supplemental wash dispenser 140. In some alternative aspects, the liquid reservoir may not be present, and the wash effluent 155 can be directly formed from the wash liquid as it falls to the bottom of vessel 110. This can potentially result in uneven flow rates of wash effluent 155 leaving the vessel, which is why the reservoir 145 is typically present.

In various aspects, the components shown in FIG. 1 can be used as part of a two-step metal carbonation process. In the example configuration shown in FIG. 1, instead of simply recycling output flow 155 from reservoir 145 back into vessel 110, the output flow 155 (corresponding to the CO₂-enriched wash effluent) can be passed 159 into precipitation vessel 160. In other aspects, the output flow can be passed into a separate zone within a single vessel (not shown). The CO₂-enriched wash effluent is combined in precipitation vessel (or zone) 160 with metal reagent(s) 175. In some aspects, metal reagent(s) 175 can correspond to particles of such metal oxides, hydroxides, metal sulfides and/or metal silicates. In some aspects, the metal reagent(s) can correspond to particles containing one or more of calcium oxide, calcium hydroxide, calcium silicate, calcium sulfide, magnesium oxide, magnesium hydroxide, magnesium silicate, and/or magnesium sulfide. Such particles can be formed, for example, by optionally pulverizing 170 and/or otherwise preparing a metal reagent source 172. Various types of minerals can include metal oxides, metal hydroxides, metal sulfides, and/or metal silicates that can be prepared to form particles containing metal reagents. Optionally, additional water 161 can also be introduced into precipitation vessel 160. The output flow 155 (containing carbonate ions), metal reagent(s) 175, and optional additional water 161 can be mixed in precipitation vessel 160 to form solid metal carbonate particles. The solid metal carbonate particles can be primarily withdrawn from precipitation vessel 160 as a metal carbonate product stream 165. A precipitation vessel effluent 181 is also generated, to allow the liquid from the precipitation vessel to be recycled for use as aqueous wash liquid. This precipitation vessel effluent 181 corresponds to a CO₂-depleted liquid effluent. It is noted that some small particles may remain suspended in the precipitation vessel effluent 181. A particulate filter 180 can be used to remove particles larger than a target size from the precipitation vessel effluent 181 prior to recycle. Optionally, a portion of precipitation vessel effluent 181 can be purged as part of purge stream 157. Optionally, a cooling loop 168 can be used to maintain a target temperature within the precipitation vessel 160. The metal carbonate product stream 165 can undergo any convenient type of further processing 190, such as drying, purification, and/or transport.

It is noted that one option for constructing a system to perform metal carbonation as part of flue gas scrubbing is to retrofit an existing scrubbing system. For example, in some conventional scrubbing systems, the Venturi contacting devices and disengaging vessel can already be present. To retrofit the scrubbing system, the aqueous wash in the contacting devices can be changed to allow for increased pH during operation. Additionally, instead of recycling the aqueous reservoir directly to the contacting devices, at least a portion of the aqueous reservoir can be passed into a second zone (such as a second vessel) to allow for metal carbonate formation. The liquid formed after separating out the metal carbonates can then be used as recycle to the contacting devices, optionally after filtration to reduce or minimize the amount of particles returned to the scrubbing system.

### Description of Process Flows

A CO₂-containing stream from a process, such as flue gas from an FCC process, can correspond to a gas flow having a CO₂ content between 0.1 vol % to 30 vol %, or 0.1 vol % to 15 vol %, or 0.1 vol % to 10 vol %, or 1.0 vol % to 15 vol %, or 1.0 vol % to 10 vol %, or 1.0 vol % to 5.0 vol %, or 3.0 vol % to 15 vol %, or 3.0 vol % to 10 vol %. The CO₂-containing stream can optionally further include one or more nitrogen contaminants different from N₂, such as HCN, NH₃, NO, or NO₂. Such nitrogen contaminants can be present, alone or in combination, in an amount between 0.001 vol % (10 vppm) to 2.0 vol %, or 0.001 vol % to 1.0 vol %, or 0.001 vol % to 0.1 vol %, or 0.01 vol % to 2.0 vol %, or 0.01 vol % to 1.0 vol %. Additionally or alternately, the CO₂-containing stream can optionally further include one or more sulfur contaminants such as H₂S or SO₂. Such sulfur contaminants can be present, alone or in combination, in an amount between 0.001 vol % (10 vppm) to 2.0 vol %, or 0.001 vol % to 1.0 vol %, or 0.001 vol % to 0.1 vol %, or 0.01 vol % to 2.0 vol %, or 0.01 vol % to 1.0 vol %. After passing through the scrubbing system, the resulting scrubbed flue gas (corresponding to a CO₂-depleted gas effluent) can contain a reduced or minimized amount of the one or more nitrogen contaminants and/or one or more sulfur contaminants. In some aspects, a molar ratio of the one or more nitrogen contaminants in the CO₂-depleted gas effluent to the one or more nitrogen contaminants in the process flue gas can be 0.5 or less, or 0.1 or less, such as down to having substantially content of the one or more nitrogen contaminants (molar ratio of 0.01 or less). In some aspects, a molar ratio of the one or more sulfur contaminants in the CO₂-depleted gas effluent to the one or more sulfur contaminants in the process flue gas can be 0.5 or less, or 0.1 or less, such as down to having substantially content of the one or more sulfur contaminants (molar ratio of 0.01 or less).

In addition to gas phase components, a CO₂-containing stream from a process can also contain particles, such as catalyst fines or coke fines. The particle content of the CO₂-containing stream can be 5.0 mg/Nm³-500 mg/Nm³ of the CO₂-containing stream, or 5.0 mg/Nm³-100 mg/Nm³.

The gas phase effluent from the disengaging drum (or other vessel) can correspond to a CO₂-depleted gas phase effluent corresponding to a CO₂-depleted flue gas. The CO₂-depleted flue gas can have a CO₂ content of 1.0 vol % or less. In some aspects, a molar ratio of CO₂ in the CO₂-depleted flue gas to CO₂ in the process flue gas (the input flow to the disengaging drum) can be 0.05 or less (˜95% or more CO₂ removal), or 0.01 or less (˜99% or more CO₂ removal), such as down to having substantially no CO₂ content in the CO₂-depleted flue gas (molar ratio of 0.001 or less).

The temperature in the disengaging drum (or other vessel for contacting the CO₂-containing gas with an aqueous wash liquid) can be between 5° C. and 100° C. The pressure in the disengaging drum (or other vessel) can be any convenient pressure, such as a pressure of 90 kPa-a to 300 kPa-a, or 90 kPa-a to 150 kPa-a.

In various aspects, the pH of the aqueous wash liquid used in the contacting device and/or the aqueous reservoir in the disengaging drum (or other vessel) while contacting the CO₂-containing stream can be 9.8 to 13.0, or 10.0 to 13.0, or 10.5 to 13.0, or 9.8 to 11.2, or 10.0 to 11.2, or 9.8 to 11.0, or 10.0 to 11.2, or 10.0 to 11.0, or 10.2 to 11.2, or 10.2 to 11.0, or 10.5 to 11.2, or 10.5 to 11.0. During operation, the carbonate ion (CO₃²⁻) content in the aqueous reservoir can be 0.05 mol/L to 10 mol/L, or 0.05 mol/L to 1.0 mol/L, or 0.1 mol/L to 10 mol/L, or 0.1 mol/L to 1.0 mol/L. The carbonate ion concentration can be calculated by measuring the total organic carbon content, which includes CO₂/bicarbonate ion/carbonate ion in the measurement. The carbonate ion content can then be determined based on the equilibrium distribution based on the pH. The base used for achieving the target pH in the aqueous reservoir can be an alkali hydroxide, such as sodium hydroxide or potassium hydroxide.

By increasing the pH in the contacting device and/or the disengaging drum, substantially complete capture of CO₂ can be achieved at higher flow rates of the CO₂-containing stream. In the exhaust gas exiting from the disengaging drum that is passed into the remaining portion of the scrubbing system, the CO₂ content can be 1.0 vol % or less, or 0.5 vol % or less, or 0.1 vol % or less, such as down to 0.01 vol % (100 vppm) or possibly still lower.

The metal reagent(s) used for the metal carbonation reaction can contain metals that readily precipitate when metal carbonates are formed under basic conditions. Examples of metal reagents include, but are not limited to, magnesium oxides, calcium oxides, magnesium hydroxides, calcium hydroxides, magnesium sulfides, calcium sulfides, magnesium silicates, and calcium silicates. It is noted that if a mineral source is used as the source of the metal reagent(s), other metals may also be present, such as other metal oxides and/or other metal silicates.

In the precipitation vessel, the CO₂-enriched wash effluent can be mixed with the metal reagent(s) in any convenient ratio. Generally, the metal carbonation reaction is stoichiometric, so one option is to have a roughly stoichiometric (or greater) molar flow of metal reagent(s) into the precipitation vessel. However, as a practical matter, a sub-stoichiometric molar flow rate of metal reagent(s) can be used, in order to reduce or minimize the potential for excess dissolved mineral to be returned to the zone in the disengaging vessel where precipitation is not desired. Such a sub-stoichiometric molar flow will result in some return of carbonate ions back to the disengaging drum during recycle. In some aspects, the ratio of combined moles of calcium oxide and magnesium oxide passed into the precipitation vessel versus the moles of carbonate in the input flow to the precipitation vessel can be 0.1 to 1.0, or 0.1 to 0.9, or 0.5 to 1.0, or 0.5 to 0.9. In some aspects, the ratio of combined moles of calcium silicate and magnesium silicate passed into the precipitation vessel versus the moles of carbonate in the input flow to the precipitation vessel can be 0.1 to 1.0, or 0.1 to 0.9, or 0.5 to 1.0, or 0.5 to 0.9. In some aspects, the ratio of combined moles of calcium hydroxide and magnesium hydroxide passed into the precipitation vessel versus the moles of carbonate in the input flow to the precipitation vessel can be 0.1 to 1.0, or 0.1 to 0.9, or 0.5 to 1.0, or 0.5 to 0.9. In some aspects, the ratio of combined moles of calcium-containing metal reagents passed into the precipitation vessel versus the moles of carbonate in the input flow to the precipitation vessel can be 0.1 to 1.0, or 0.1 to 0.9, or 0.5 to 1.0, or 0.5 to 0.9. In some aspects, the ratio of combined moles of magnesium-containing metal reagents passed into the precipitation vessel versus the moles of carbonate in the input flow to the precipitation vessel can be 0.1 to 1.0, or 0.1 to 0.9, or 0.5 to 1.0, or 0.5 to 0.9. In some aspects, the ratio of combined moles of total metal reagents (calcium and/or magnesium oxides, hydroxides, silicates, and sulfides) passed into the precipitation vessel versus the moles of carbonate in the input flow to the precipitation vessel can be 0.1 to 1.0, or 0.1 to 0.9, or 0.5 to 1.0, or 0.5 to 0.9. In some aspects, the ratio of combined moles of calcium oxide, magnesium oxide, calcium silicate, and magnesium silicate passed into the precipitation vessel versus the moles of carbonate in the input flow to the precipitation vessel can be 0.1 to 1.0, or 0.1 to 0.9, or 0.5 to 1.0, or 0.5 to 0.9.

The temperature in the precipitation vessel can be any convenient temperature for precipitation of metal carbonates. In some aspects, the temperature in the precipitation vessel can be 5° C. to 100° C., or 30° C. to 80° C., or 20° C. to 70° C., or 5° C. to 70° C. It is noted that formation of metal carbonates tends to be exothermic, so the temperature in the precipitation vessel may be higher than the temperature of the CO₂-containing aqueous liquid as it enters the precipitation vessel. The metal carbonation reaction can be performed at any convenient pressure. In some aspects, a pressure of ambient pressure or higher can be suitable. In some aspects, the pressure in the precipitation vessel can be 90 kPa-a to 300 kPa-a, or 90 kPa-a to 150 kPa-a. The pH in the precipitation vessel can be a convenient pH for inducing precipitation of magnesium carbonate or calcium carbonate. In some aspects, the pH in the precipitation vessel can be substantially similar to the pH in the disengaging drum. In some aspects, the pH in the precipitation vessel can be 9.8 to 13.0, or 10.0 to 13.0, or 10.2 to 13.0, or 10.5 to 13.0, or 9.8 to 11.2, or 10.0 to 11.2, or 10.2 to 11.2, or 10.5 to 11.2, or 9.8 to 11.0, or 10.0 to 11.0, or 10.2 to 11.0, or 10.5 to 11.0.

Forming metal carbonates reduces the carbonate ion content in the liquid phase, so that the effluent from the precipitation vessel has a reduced carbonate ion content. This precipitation vessel effluent can be referred to as a CO₂-depleted effluent. In various aspects, the CO₂-depleted effluent from the precipitation reaction has a carbonate concentration of 0.001 mol/L to 5.0 mol/L, or 0.01 mol/L to 0.5 mol/L. In various aspects, a molar ratio of carbonate ions in the CO₂-depleted effluent from the precipitation vessel to carbonate ions in the CO₂-enriched wash effluent (i.e., the input flow to the precipitation vessel) can be 0.75 or less, or 0.25 or less, or 0.1 or less, or 0.01 or less, such as down to having substantially no carbonate ions remaining in the precipitation vessel effluent (0.001 or less).

Transport and/or Other Uses of Metal Carbonates

The metal carbonates formed by metal carbonation can be used in a variety of manners. One option is simply to use the metal carbonates as a convenient solid form for sequester. Another option is to use the metal carbonates as a convenient form for transport of CO₂, followed by sequester in another location on-site at a facility, or possibly after transport to a different sequester location. In this type of aspect, after forming the metal carbonates, the metal carbonates are transported to another location. Because metal carbonates are relatively safe for transport, the metal carbonates can be transported by a convenient method, such as truck or train. The metal carbonates can then be reacted to liberate the CO₂ while generating a convenient form of metal reagent. The resulting CO₂ can then be sequestered, while the metal reagent can be transported back to the original processing site for further formation of metal carbonates.

Still another option can be to use the metal carbonates as a raw material. Examples of materials that can potentially benefit from use of metal carbonates as a reagent and/or as a structural or filler material include, but are not limited to, paint, paper, plastic, magnesite gypsum board, concrete aggregate, other building materials, and soil enhancers/fertilizers. Still another option can be to use the metal carbonates as a backfill material for reclamation of depleted mines.

Integration with FCC Process and/or Other Processes

One example of a process that can be integrated with metal carbonation for CO₂ removal is a fluid catalytic cracking (FCC) process. The overhead gas produced by the regenerator of an FCC reaction system corresponds to a CO₂-containing process flue gas.

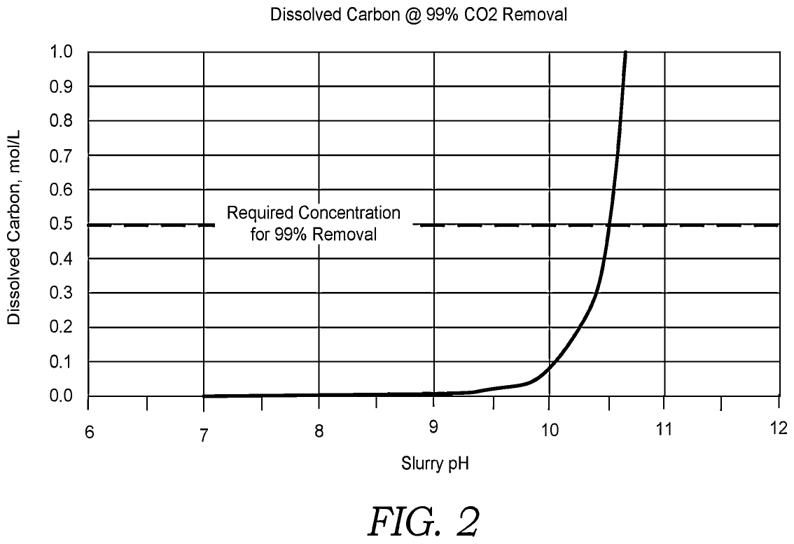

In various aspects, increasing the pH of the wash liquid in the disengaging drum can allow for increased transfer of CO₂ from the process flue gas to the wash liquid. FIG. 2 shows the solubility of CO₂ in an aqueous liquid. As shown in FIG. 2, at pH values below 10.0, the solubility of CO₂ is less than 0.1 mol/L. For traditional volumes of wash liquid relative to mass flow rate of CO₂ in the overhead gas, in order to achieve substantially complete capture of CO₂, the wash liquid in the disengaging drum needs to be able to accommodate a CO₂ concentration (such as in the form of carbonate ions) of 0.1 mol/L or more, or 0.2 mol/L or more, or 0.5 mol/L or more. Thus, pH values greater than 10.0 provide sufficient solubility so that substantially all of the CO₂ in the overhead gas can be dissolved in the wash liquid.

In the example shown in FIG. 2, a line is included at 0.5 mol/L, which represents the minimum CO₂ concentration that would need to be dissolved in the wash liquid to capture 99 vol % or more of the CO₂ from an FCC flue gas for a representative system while maintaining conventional flow rates for the wash liquid. In the example shown in FIG. 2, a pH of 10.5 is sufficient to allow the wash liquid to dissolve 0.5 mol/L or more of CO₂. It is noted that at pH levels of 10.0 and higher, the solubility of CO₂ in an aqueous medium increases exponentially. Thus, changing the volume flow rate of the wash liquid while maintaining a pH of less than 10.0 is not a practical solution for increasing the amount of CO₂ capture.

An example of a suitable reactor for performing an FCC process can be a riser reactor. Within the reactor riser, the feeds for co-processing can be contacted with a catalytic cracking catalyst under cracking conditions thereby resulting in spent catalyst particles containing carbon deposited thereon and a lower boiling product stream. The cracking conditions can include: temperatures from 900° F. to 1060° F. (482° C. to ^{˜}571° C.), or 950° F. to 1040° F. (510° C. to ˜560° C.); hydrocarbon partial pressures from 10 to 50 psia (˜70-350 kPa-a), or from 20 to 40 psia (˜140-280 kPa-a); and a catalyst to feed (wt/wt) ratio from 3 to 8, or 5 to 6, where the catalyst weight can correspond to total weight of the catalyst composite. Steam may be concurrently introduced with the feed into the reaction zone. The steam may comprise up to 5 wt % of the feed. In some aspects, the FCC feed residence time in the reaction zone can be less than 5 seconds, or from 3 to 5 seconds, or from 2 to 3 seconds.

Catalysts suitable for use within the FCC reactor herein can be fluid cracking catalysts comprising either a large-pore molecular sieve or a mixture of at least one large-pore molecular sieve catalyst and at least one medium-pore molecular sieve catalyst. Large-pore molecular sieves suitable for use herein can be any molecular sieve catalyst having an average pore diameter greater than ^{˜}0.7 nm which are typically used to catalytically “crack” hydrocarbon feeds. In various aspects, both the large-pore molecular sieves and the medium-pore molecular sieves used herein be selected from those molecular sieves having a crystalline tetrahedral framework oxide component. For example, the crystalline tetrahedral framework oxide component can be selected from the group consisting of zeolites, tectosilicates, tetrahedral aluminophosphates (ALPOs) and tetrahedral silicoaluminophosphates (SAPOs). Preferably, the crystalline framework oxide component of both the large-pore and medium-pore catalyst can be a zeolite. More generally, a molecular sieve can correspond to a crystalline structure having a framework type recognized by the International Zeolite Association. It should be noted that when the cracking catalyst comprises a mixture of at least one large-pore molecular sieve catalyst and at least one medium-pore molecular sieve, the large-pore component can typically be used to catalyze the breakdown of primary products from the catalytic cracking reaction into clean products such as naphtha and distillates for fuels and olefins for chemical feedstocks.

In some aspects, the large-pore zeolite catalysts and/or the medium-pore zeolite catalysts can be present as “self-bound” catalysts, where the catalyst does not include a separate binder. In some aspects, the large-pore and medium-pore catalysts can be present in an inorganic oxide matrix component that binds the catalyst components together so that the catalyst product can be hard enough to survive inter-particle and reactor wall collisions. The inorganic oxide matrix can be made from an inorganic oxide sol or gel which can be dried to “glue” the catalyst components together. Preferably, the inorganic oxide matrix can be comprised of oxides of silicon and aluminum. It can be preferred that separate alumina phases be incorporated into the inorganic oxide matrix. Species of aluminum oxyhydroxides-γ-alumina, boehmite, diaspore, and transitional aluminas such as α-alumina, β-alumina, γ-alumina, δ-alumina, ε-alumina, κ-alumina, and ρ-alumina can be employed. Preferably, the alumina species can be an aluminum trihydroxide such as gibbsite, bayerite, nordstrandite, or doyelite. Additionally or alternately, the matrix material may contain phosphorous or aluminum phosphate. Optionally, the large-pore catalysts and medium-pore catalysts be present in the same or different catalyst particles, in the aforesaid inorganic oxide matrix.

In the FCC reactor, the cracked FCC product can be removed from the fluidized catalyst particles. Preferably this can be done with mechanical separation devices, such as an FCC cyclone. The FCC product can be removed from the reactor via an overhead line, cooled and sent to a fractionator tower for separation into various cracked hydrocarbon product streams. These product streams may include, but are not limited to, a light gas stream (generally comprising C₄ and lighter hydrocarbon materials), a naphtha (gasoline) stream, a distillate (diesel and/or jet fuel) steam, and other various heavier gas oil product streams. The other heavier stream or streams can include a bottoms stream.

In the FCC reactor, after removing most of the cracked FCC product through mechanical means, the majority of, and preferably substantially all of, the spent catalyst particles can be conducted to a stripping zone within the FCC reactor. The stripping zone can typically contain a dense bed (or “dense phase”) of catalyst particles where stripping of volatiles takes place by use of a stripping agent such as steam. There can also be space above the stripping zone with a substantially lower catalyst density which space can be referred to as a “dilute phase”. This dilute phase can be thought of as either a dilute phase of the reactor or stripper in that it will typically be at the bottom of the reactor leading to the stripper.

In some aspects, the majority of, and preferably substantially all of, the stripped catalyst particles are subsequently conducted to a regeneration zone wherein the spent catalyst particles are regenerated by burning coke from the spent catalyst particles in the presence of an oxygen containing gas, preferably air thus producing regenerated catalyst particles. This regeneration step restores catalyst activity and simultaneously heats the catalyst to a temperature from 1200° F. to 1400° F. (649 to 760° C.). The majority of, and preferably substantially all of the hot regenerated catalyst particles can then be recycled to the FCC reaction zone where they contact injected FCC feed.

It is noted that while the above integration is described in relation to a fluid catalytic cracking unit, other refinery and/or industrial processes can also generate flue gases with somewhat similar properties to the overhead gas from an FCC unit. Examples of other processes that generate flue gases that may be suitable for metal carbonate formation for CO₂ capture include, but are not limited to, fluidized coking processes, fluidized bed combustion processes, and power generation processes, such as solid fuel power generation processes.

### Additional Embodiments

Embodiment 1. A method for forming metal carbonates, comprising: contacting a process flue gas comprising 0.1 vol % to 30 vol % CO₂ with an aqueous wash liquid in a wash contacting device associated with a vessel to form a CO₂-depleted gas effluent and a CO₂-enriched wash effluent, the CO₂-enriched wash effluent comprising a pH of 9.8 to 13.0 and a carbonate ion content of 0.05 mol/L or more; passing at least a portion of the CO₂-enriched wash effluent into a precipitation zone; and contacting the at least a portion of the CO₂-enriched wash effluent with at least one of a calcium reagent and a magnesium reagent to form a CO₂-depleted liquid and at least one of calcium carbonate and magnesium carbonate, the at least one of a calcium reagent and a magnesium reagent comprising magnesium oxide, magnesium silicate, magnesium hydroxide, magnesium sulfide, calcium oxide, calcium silicate, calcium hydroxide, calcium sulfide, or a combination thereof, wherein the aqueous wash liquid comprises at least a portion of the CO₂-depleted liquid, the precipitation zone optionally being in a second vessel.

Embodiment 2. The method of Embodiment 1, wherein the CO₂-enriched wash effluent comprises a pH of 10.0 to 11.2, or wherein the CO₂-enriched wash effluent comprises a pH of 10.5 to 11.0.

Embodiment 3. The method of any of the above embodiments, wherein the CO₂-depleted gas effluent comprises a CO₂ content of 1.0 vol % or less.

Embodiment 4. The method of any of the above embodiments, wherein the at least one of a calcium reagent and a magnesium reagent comprises one or more of magnesium oxide, magnesium silicate, calcium oxide, and calcium silicate; or wherein the at least one of a calcium reagent and a magnesium reagent comprises magnesium oxide, calcium oxide, or a combination thereof.

Embodiment 5. The method of any of the above embodiments, wherein a molar ratio of the at least one of a calcium reagent and a magnesium reagent to carbonate ions in the CO₂-enriched wash effluent if 0.1 to 1.0.

Embodiment 6. The method of any of the above embodiments, wherein the CO₂-depleted liquid comprises a carbonate ion content of 0.001 mol/L or more, a ratio of the carbonate ion content in the CO₂-depleted liquid to the carbonate ion content in the at least a portion of the CO₂-enriched wash effluent being 0.75 or less.

Embodiment 7. The method of any of the above embodiments, wherein the aqueous wash liquid comprises a carbonate ion content of 0.001 mol/L or more, a ratio of the carbonate ion content in the aqueous was liquid to the carbonate ion content in the at least a portion of the CO₂-enriched wash effluent being 0.75 or less.

Embodiment 8. The method of any of the above embodiments, wherein a ratio of CO₂ in the process flue gas to CO₂ in the CO₂-depleted flue gas is 0.05 or less.

Embodiment 9. The method of any of the above embodiments, wherein a ratio of CO₂ in the process flue gas to CO₂ in the CO₂-depleted flue gas is 0.01 or less.

Embodiment 10. The method of any of the above embodiments, wherein the process flue gas comprises a particle content of 5.0 mg/Nm³ or more, or wherein the CO₂-depleted gas effluent comprises a particle content of less than 5.0 mg/Nm³, or a combination thereof.

Embodiment 11. The method of any of the above embodiments, wherein the process flue gas comprises 0.001 vol % to 2.0 vol % of nitrogen contaminants, or wherein the process flue gas comprises 0.001 vol % to 2.0 vol % of sulfur contaminants, or a combination thereof.

Embodiment 12. The method of Embodiment 11, wherein a molar ratio of nitrogen contaminants in the CO₂-depleted gas effluent to nitrogen contaminants in the process flue gas is 0.1 or less, or wherein a molar ratio of sulfur contaminants in the CO₂-depleted gas effluent to sulfur contaminants in the process flue gas is 0.1 or less, or a combination thereof.

Embodiment 13. The method of any of the above embodiments, wherein process flue gas comprises a process flue gas from at least one of a fluid catalytic cracking process and a fluidized coking process.

Embodiment 14. The method of any of the above embodiments, wherein the process flue gas is contacted with a spray of the aqueous wash fluid.

Embodiment 15. A system for integrating metal carbonation with a gas phase scrubbing system, comprising: a wash contacting device for contacting a gas flow with an aqueous wash liquid, the wash contacting device comprising a flue gas inlet, a wash liquid inlet, and a wash fluid outlet, the flue gas inlet being in fluid communication with an overhead gas outlet of at least one of a fluid catalytic cracking process and a fluidized coking process; a disengaging vessel comprising a disengaging fluid inlet in fluid communication with the wash fluid outlet, a gas outlet, and a disengaging effluent outlet, the disengaging vessel comprising an aqueous reservoir having a pH of 9.8 to 13.0, the aqueous reservoir comprising at least a portion of the aqueous wash liquid; and a precipitation vessel comprising a wash effluent inlet in fluid communication with the wash effluent outlet, a liquid effluent outlet in fluid communication with the wash liquid inlet, a particle inlet, and a carbonate solids outlet, the precipitation vessel further comprising a mixer, the contacting device optionally comprising an aqueous wash liquid sprayer for contacting the gas flow with the aqueous wash liquid.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A method for forming metal carbonates, comprising:
contacting a process flue gas comprising 0.1 vol % to 30 vol % CO₂ with an aqueous wash liquid in a wash contacting device associated with a vessel to form a CO₂-depleted gas effluent and a CO₂-enriched wash effluent, the CO₂-enriched wash effluent comprising a pH of 9.8 to 13.0 and a carbonate ion content of 0.05 mol/L or more;
passing at least a portion of the CO₂-enriched wash effluent into a precipitation zone; and
contacting the at least a portion of the CO₂-enriched wash effluent with at least one of a calcium reagent and a magnesium reagent to form a CO₂-depleted liquid and at least one of calcium carbonate and magnesium carbonate, the at least one of a calcium reagent and a magnesium reagent comprising magnesium oxide, magnesium silicate, magnesium hydroxide, magnesium sulfide, calcium oxide, calcium silicate, calcium hydroxide, calcium sulfide, or a combination thereof,
wherein the aqueous wash liquid comprises at least a portion of the CO₂-depleted liquid.

2. The method of claim 1, wherein the precipitation zone is in a second vessel.

3. The method of claim 1, wherein the CO₂-enriched wash effluent comprises a pH of 10.0 to 11.2.

4. The method of claim 1, wherein the CO₂-enriched wash effluent comprises a pH of 10.5 to 11.0.

5. The method of claim 1, wherein the CO₂-depleted gas effluent comprises a CO₂ content of 1.0 vol % or less.

6. The method of claim 1, wherein the at least one of a calcium reagent and a magnesium reagent comprises one or more of magnesium oxide, magnesium silicate, calcium oxide, and calcium silicate.

7. The method of claim 1, wherein the at least one of a calcium reagent and a magnesium reagent comprises magnesium oxide, calcium oxide, or a combination thereof.

8. The method of claim 1, wherein a molar ratio of the at least one of a calcium reagent and a magnesium reagent to carbonate ions in the CO₂-enriched wash effluent if 0.1 to 1.0.

9. The method of claim 1, wherein the CO₂-depleted liquid comprises a carbonate ion content of 0.001 mol/L or more, a ratio of the carbonate ion content in the CO₂-depleted liquid to the carbonate ion content in the at least a portion of the CO₂-enriched wash effluent being 0.75 or less.

10. The method of claim 1, wherein the aqueous wash liquid comprises a carbonate ion content of 0.001 mol/L or more, a ratio of the carbonate ion content in the aqueous wash liquid to the carbonate ion content in the at least a portion of the CO₂-enriched wash effluent being 0.75 or less.

11. The method of claim 1, wherein a ratio of CO₂ in the process flue gas to CO₂ in the CO₂-depleted flue gas is 0.05 or less.

12. The method of claim 1, wherein a ratio of CO₂ in the process flue gas to CO₂ in the CO₂-depleted flue gas is 0.01 or less.

13. The method of claim 1, wherein the process flue gas comprises a particle content of 5.0 mg/Nm³ or more.

14. The method of claim 1, wherein the CO₂-depleted gas effluent comprises a particle content of less than 5.0 mg/Nm³.

15. The method of claim 1, wherein the process flue gas comprises 0.001 vol % to 2.0 vol % of nitrogen contaminants, or wherein the process flue gas comprises 0.001 vol % to 2.0 vol % of sulfur contaminants, or a combination thereof.

16. The method of claim 15, wherein a molar ratio of nitrogen contaminants in the CO₂-depleted gas effluent to nitrogen contaminants in the process flue gas is 0.1 or less, or wherein a molar ratio of sulfur contaminants in the CO₂-depleted gas effluent to sulfur contaminants in the process flue gas is 0.1 or less, or a combination thereof.

17. The method of claim 1, wherein process flue gas comprises a process flue gas from at least one of a fluid catalytic cracking process and a fluidized coking process.

18. The method of claim 1, wherein the process flue gas is contacted with a spray of the aqueous wash fluid.

19. A system for integrating metal carbonation with a gas phase scrubbing system, comprising:
a wash contacting device for contacting a gas flow with an aqueous wash liquid, the wash contacting device comprising a flue gas inlet, a wash liquid inlet, and a wash fluid outlet, the flue gas inlet being in fluid communication with an overhead gas outlet of at least one of a fluid catalytic cracking process and a fluidized coking process;
a disengaging vessel comprising a disengaging fluid inlet in fluid communication with the wash fluid outlet, a gas outlet, and a disengaging effluent outlet, the disengaging vessel comprising an aqueous reservoir having a pH of 9.8 to 13.0, the aqueous reservoir comprising at least a portion of the aqueous wash liquid; and
a precipitation vessel comprising a wash effluent inlet in fluid communication with the wash effluent outlet, a liquid effluent outlet in fluid communication with the wash liquid inlet, a particle inlet, and a carbonate solids outlet, the precipitation vessel further comprising a mixer.

20. The system of claim 19, wherein the contacting device comprises an aqueous wash liquid sprayer for contacting the gas flow with the aqueous wash liquid.
